(19) United States
(12) Patent Application Publication
(10) Pub. No.: US 2003/0200689 A1
(43) Pub. Date: Oct. 30, 2003

(54) Hangtags for lamps having fabric-covered lampshades

(76) Inventor: Richard Cohon, Hackensack, NJ (US)

Correspondence Address: Kirschstein, Ottinger, Israel & Schiffmiller, P.C., 489 Fifth Avenue, New York, NY, 10017-6105, US

(21) Appl. No.: 10/132,897

(22) Filed: Apr. 25, 2002

(51) Int. Cl. G09F 3/10

(52) U.S. Cl. 40/673

(57) ABSTRACT

A hangtag has a sample fabric portion of the same fabric material used to cover a lampshade which is protected by a covering. The fabric portion is accessible to enable a consumer to touch and feel the sample fabric portion and determine whether to proceed with purchasing the lampshade despite the inability to directly touch the fabric material on the lampshade due to the presence of the covering.

### BACKGROUND OF THE INVENTION

1. Field of the Invention

The present invention generally relates to a hangtag associated with a lamp having a fabric-covered lampshade protected by a covering material and, more particularly, to the feature of enabling a consumer to feel the fabric used in the lampshade despite the inability to directly touch the fabric on the lampshade.

2. Description of the Related Art

A tag or label is often attached to an item being sold and bears information related to the item. In the lamp industry, a tag is attached to a lamp, typically by being hung from the neck or harp of the lamp, or is attached to a lampshade, and bears information such as the dimensions of the lampshade, the name and address of the manufacturer or retailer, the universal product code (UPC) symbol for identifying the lamp, trademark or name of the lamp or supplier, and so forth. The tag is typically a slip of heavyweight paper on which such information is printed, and is removed from the lamp or the lampshade and discarded after the sale has been completed.

Lampshades are sold either together with lamps, or separately, and are often constituted of a stiff backing material covered by a fabric material and are known as “hardback” lampshades. The backing material provides the strength, whereas the fabric material provides the aesthetics. Virtually all fabric-covered, hardback lampshades are covered with a thin, flexible, transparent film of a covering material to protect the fabric from being soiled while being transported or resting on store shelves, and also from contact by consumers who repeatedly touch and feel the fabric during shopping and, in the process, soil the lampshade fabric, thereby making it unfit for sale. There are certain consumers who will not purchase an item unless they can feel and touch it and, in the lampshade industry, this option has been foreclosed.

### SUMMARY OF THE INVENTION

### OBJECTS OF THE INVENTION

Accordingly, it is a general object of this invention to enable a consumer to feel the fabric used in a lampshade despite the inability to directly touch the fabric on the lampshade.

More particularly, it is an object of the present invention to provide an improved hangtag which not only bears information related to the item being sold, but also enables a consumer to touch and feel a fabric used in the fabrication of the item.

Still another object of the present invention is to provide a hangtag at minimal increased cost during fabrication of a lampshade.

### FEATURES OF THE INVENTION

In keeping with the above objects and others which will become apparent hereinafter, one feature of the present invention resides, briefly stated, in a tag or label for an item, for example, a lamp, a lampshade, or any item having a fabric protected by a covering prior to sale of the item and, as a result, preventing a consumer from directly touching the fabric on the item prior to the sale.

The tag or label includes a support for attachment to the item, and a sample fabric portion identical in constitution to the fabric on the item. The fabric portion is supported by the support and is accessible for touching by the consumer. Thus, in accordance with this invention, the consumer can touch and feel the fabric portion on the tag and determine whether to proceed with the sale despite the inability to directly touch the covered fabric on the item prior to sale.

It is especially advantageous if the tag is made during fabrication of the lampshade from waste or remnant materials. During the fabrication of a hardback lampshade, the fabric is laminated over a stiff but bendable, backing material, typically a plastic such as a styrene. When the lampshade is fabricated and deformed into a frusto-conical shape, there are waste materials left over. These waste materials can be used to make the tag. Thus, the backing material serves as the support, and the fabric serves as the fabric portion, for the tag.

The tag support is a planar sheet, and can have two sheet portions folded over each other. The fabric portion is likewise a planar sheet and can be laminated over the entire support, or over a part of the support, for example, on one of the folded sheet portions. The fabric portion is accessible to touch, either by direct exposure, or after unfolding the sheet portions. Even in the case of a folded support, the fabric portion may be accessed without unfolding the sheet portions by providing an aperture or window in the other of the sheet portions and through which the fabric portion is exposed.

Information related to the item may be printed on the support, but it is preferable to print the information on an indicia sheet. Preferably, the indicia sheet is adhered to the support, thereby constituting the tag as a tripartite layered construction.

A hole is formed through the tag, and a tie is passed through the hole and hung from a convenient part of the lamp or lampshade within ready viewing and accessibility to the consumer.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a broken-away view of a lamp with a lampshade shown in section, and having a tag in accordance with one embodiment of this invention;

FIG. 2 is a broken-away, enlarged sectional view taken on line 2-2 of FIG. 1;

FIG. 3 is a perspective view of a tag in accordance with another embodiment of this invention; and

FIG. 4 is a perspective view of a tag in accordance with still another embodiment of this invention.

### DETAILED DESCRIPTION OF THE PREFERRED EMBODIMENTS

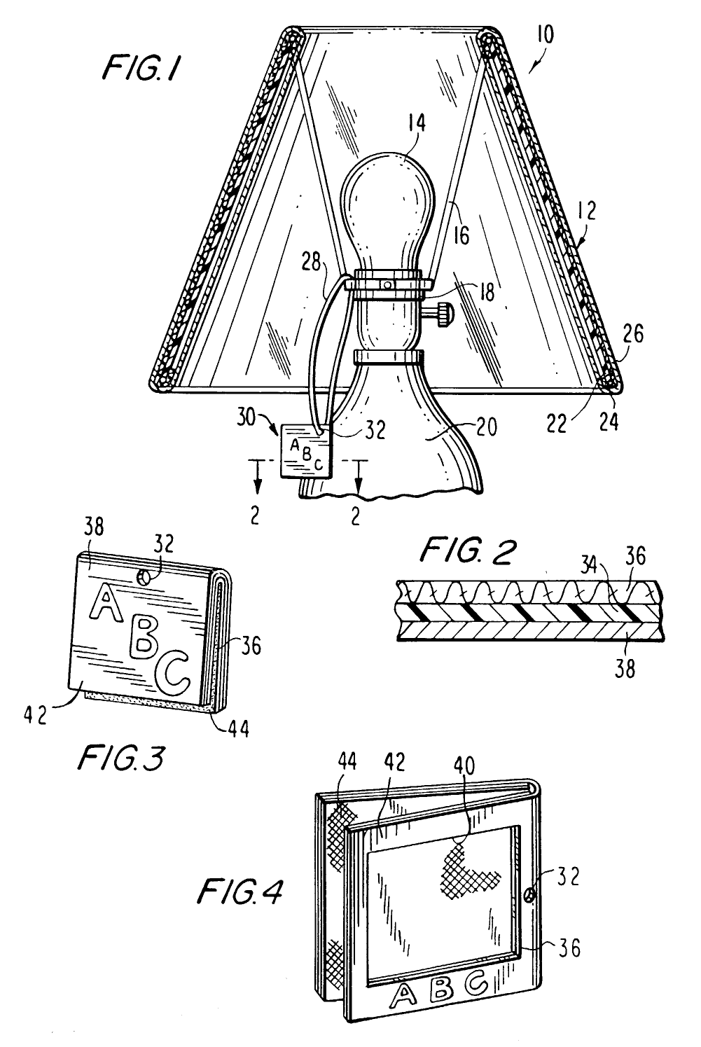

Referring to FIG. 1, reference numeral 10 generally identifies a lamp having a lampshade 12 mounted in a predetermined position relative to an electrical light bulb 14 by a lamp harp 16 mounted on a bulb socket 18 which, in turn, is mounted on an upper region of a lamp tube which is mounted within a lamp base 20. The lamp is conventional and, hence, the lamp cord, the lamp switch and the lamp wiring have not been shown.

The lampshade is likewise conventional and, in the illustrated case of a hardbacked lampshade, includes a stiff but bendable, backing material 22 preferably made of a light-transmissive plastic material such as styrene, and a fabric material 24 such as any cloth made from thread or fibers, whether woven, knitted or felted. The fabric material 24 is laminated by use of an adhesive onto the backing material 22 during fabrication of the lampshade. As is known, the lampshade screens the light emitted by the bulb and is positioned far enough away from the bulb and is constituted of, or treated with, materials capable of resisting the heat caused by the bulb during use. The lampshade is preferably frusto-conical in shape as shown, but can have any configuration.

Virtually all lampshades, no matter what their configuration, and no matter whether or not they are sold separately or with the lamps, are covered with a thin, flexible, transparent film of a covering material 26, typically a plastic film, to protect the fabric material from collecting dust on store shelves, or from being soiled during transportation or display. Many consumers, perhaps from practice in the clothing field, will often touch and feel an item for sale and, in the case of a fabric-covered lampshade, the fabric is often soiled by such repeated contact with a consumer's fingers. Such soiling led to the omnipresent use of the plastic film covering material 26 on the exterior and interior surfaces of the lampshade as shown in FIG. 1. However, the use of the covering material prevents the consumer from touching the fabric, and there are many consumers who will not complete the purchase unless they can contact the fabric. It will be remembered that the lampshade fabric is a decorative item, and the texture or “hand” of the fabric is critical in certain fashion settings and interior design.

This invention proposes the use of a tag or label 30 hung by a tie 28 from the lamp 10 or the lampshade 12. The tag 30 has a hole 32 through which the tie 28 extends. The tie 28 is a long, thin piece of rope, wire or plastic which is formed into a loop and closed on itself. Preferably, one end of the tie has a passage through which the other end is pushed through in one direction, but prevented from escaping in the opposite direction.

The tag 30, as best seen in FIG. 2, includes a support 34 and a sample fabric portion 36 supported by the support. The support 34 is constituted of a planar sheet material, preferably constituted of a paper or a plastic material and, in the preferred embodiment, is identical in constitution to the backing material 22 of the lampshade. The fabric portion 36 is likewise constituted of a planar sheet material and, in the preferred embodiment, is identical in constitution to the fabric material 24 of the lampshade.

The fabric portion and the support are laminated together in surface area contact, preferably by an adhesive. The fabric portion can be laminated over one or both major surfaces of the support, or over a part of such surfaces. The support and/or the fabric portion can have a rectangular shape as shown in FIG. 1, or any other shape. The support can be a single, flat, unfolded sheet as shown in FIG. 1, or a folded sheet as shown in FIGS. 3 and 4.

The tag also bears information related to the item on sale. The information, as described above, advises the consumer of such information as the dimensions of the lampshade. This information can be printed on the support or on the fabric. However, in the preferred embodiment, this information is printed on an indicia sheet 38 which is adhered, preferably by a pressure adhesive, onto the support 34. The resulting tag has a tripartite layered construction.

In use, a consumer considering the purchase of a fabric-covered lampshade, but who is prevented from touching the lampshade due to the presence of the covering material, can nevertheless touch and feel the fabric used in the lampshade by handling the tag and, more specifically, by touching and feeling the texture and hand of the sample fabric portion on the tag. In the case of the folded tag of FIG. 3, the consumer needs to unfold the support in order to gain access to the fabric portion provided on the interior surfaces of the tag. In the case of the folded tag of FIG. 4, the consumer need not initially unfold the support, because a window 40 is cut out of one of the folded sheet portions 42 and enables the consumer's fingers to be inserted through the window to touch and feel the fabric portion 36 provided on the other of the folded sheet portions 44.

This invention is not intended to be limited to the display and sale of lampshades since any item of merchandise having a constituent piece protected from touch by a consumer can likewise be provided with a tag which supports, and provides ready access to, a sample of the constituent piece. For example, certain clothing may be displayed in a protective shroud, but the consumer can feel the texture of the clothing by a sample of the fabric incorporated on an accessible hangtag.

As previously mentioned, it is preferred that the support 34 be the backing material 22, and that the fabric portion 36 be the fabric material 24, of the lampshade. The tag is preferably made during fabrication of the lampshade, and preferably from waste or remnant materials. These left-over materials are used to make the tag and serve as an inexpensive way to provide the tag.

It will be understood that each of the elements described above, or two or more together, also may find a useful application in other types of constructions differing from the types described above.

While the invention has been illustrated and described as embodied in hangtags for lamps having fabric-covered lampshades, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

I claim:

1. A tag for an item having a fabric protected by a covering prior to sale of the item, the tag comprising:
a) a support for attachment to the item; and
b) a sample fabric portion identical in constitution to the fabric on the item, the fabric portion being supported by the support and being accessible for touching by a person to enable the person to feel the fabric portion and determine whether to proceed with the sale despite the inability of the person to directly touch the fabric on the item prior to the sale.

2. The tag of claim 1, wherein the fabric portion is laminated on the support.

3. The tag of claim 1, wherein the support is a first planar sheet, and wherein the fabric portion is a second planar sheet in surface area adhesive contact with the support.

4. The tag of claim 1, wherein the support is a paper material.

5. The tag of claim 1, wherein the support is a plastic material.

6. The tag of claim 1, wherein the support is a folded sheet.

7. The tag of claim 6, wherein the folded sheet has a pair of sheet portions, and wherein the fabric portion is supported by one of the sheet portions, and wherein the other of the sheet portions has an aperture through which the fabric portion is exposed for touching.

8. The tag of claim 1, and further comprising an indicia sheet supported by the support, for bearing indicia related to the item.

9. A tag for a lamp having a lampshade covered by a fabric which is protected by a covering prior to sale of the lamp, the tag comprising:
a) a support for attachment to the lamp; and
b) a sample fabric portion identical in constitution to the fabric on the lampshade, the fabric portion being supported by the support and being accessible for touching by a consumer to enable the consumer to feel the fabric portion and determine whether to proceed with the sale despite the inability of the consumer to directly touch the fabric on the lampshade prior to the sale.

10. The tag of claim 9, wherein the fabric portion is laminated on the support.

11. The tag of claim 9, wherein the support is a first planar sheet, and wherein the fabric portion is a second planar sheet in surface area adhesive contact with the support.

12. The tag of claim 9, wherein the support is a paper material.

13. The tag of claim 9, wherein the support is a plastic material.

14. The tag of claim 9, wherein the support is a folded sheet.

15. The tag of claim 14, wherein the folded sheet has a pair of sheet portions, and wherein the fabric portion is supported by one of the sheet portions, and wherein the other of the sheet portions has an aperture through which the fabric portion is exposed for touching.

16. The tag of claim 9, and further comprising an indicia sheet supported by the support, for bearing indicia related to the lamp.

17. The tag of claim 9, wherein the support and the fabric portion are constituted of the same material as the lampshade is constituted.

18. The tag of claim 9, wherein the support has a hole, and further comprising a tie extending through the hole and hung from the lamp.

19. A method of retailing a lamp having a lampshade, the method comprising the steps of:
a) fabricating the lampshade by covering a backing material with a fabric material;
b) covering the lampshade with a covering material to protect the fabric material prior to sale of the lamp;
c) forming a tag from the backing material and the fabric material used in the fabricating step; and
d) attaching the tag to the lamp to enable a consumer to touch and feel the fabric material on the tag and determine whether to proceed with the sale despite the inability of the consumer to directly touch the fabric material on the lampshade prior to the sale.

20. The method of claim 19, wherein the step of forming the tag is performed during the fabricating step from remnant materials left over during fabricating the lampshade.
